(19) United States
(12) Patent Application Publication
(10) Pub. No.: US 2012/0111679 A1
(43) Pub. Date: May 10, 2012

(54) LUGGAGE DEVICE

(75) Inventors: Maarten Van Den Biggelaar, Amsterdam (NL); Marinus Van Diggelen, Amsterdam (NL); Philippe Soeters, Den Haag (NL)

(73) Assignee: TRAVELTEQ B.V., Amsterdam (NL)

(21) Appl. No.: 13/003,301

(22) PCT Filed: Jul. 9, 2009
(86) PCT No.: PCT/NL2009/050415

§ 371 Date: Aug. 11, 2011

(30) Foreign Application Priority Data
Jul. 11, 2008 (NL) 1035689

(51) Int. Cl. A45C 9/00; B23P 17/00

(52) U.S. Cl. 190/8; 29/592

(57) ABSTRACT

The present invention relates to a luggage device, comprising: one or more wheels for allowing the device to roll over a surface; one or more shell parts of a substantially rigid material which define a substantially closable space of a housing; wherein the housing comprises at least a top surface, a bottom surface, a front surface and a rear surface, wherein the front surface and the rear surface are larger than the top surface and the bottom surface; one or more handles, at least one of which is movable between a first position, in which it is substantially retracted into the rear side of the housing, and a second extended position for rolling the device forward via the wheels during displacement; a seat arranged on the top surface of the housing; and wherein the housing of the luggage device can be positioned substantially upright in a first position so that the seat is directed upward for the purpose of receiving a person thereon.

### CROSS-REFERENCE TO RELATED APPLICATION

This application is the National Stage of International Application no. PCT/NL2009/050415 filed Jul. 9, 2009, which claims the benefit of Netherlands patent application number 1035689 filed Jul. 11, 2008, the contents of which are incorporated by reference as if fully set forth herein.

### FIELD OF THE INVENTION

The present invention relates to a luggage device, in particular a luggage device for receiving a sitting person thereon. The invention further relates to a method for manufacturing such a luggage device.

### BACKGROUND

Due to globalization on the one hand and liberalization of the airline industry on the other, air passenger transport is increasing rapidly. Most airlines apply standard dimensions for hand luggage, for instance about 55 cm×about 30 cm×about 25 cm. A piece of hand luggage of 50 cm×35 cm×20 cm in any case meets the requirements of (almost) all airlines. Such requirements for the available space for carrying necessities for a short flight are seen as limiting. Because of the business use of laptops, which still result in a considerable increase in the weight of hand luggage, this space may be further limited.

The great majority of commercially available hand luggage with wheels is aimed at the commercial market. This hand luggage is perceived as rather unappealing by many professionals, such as architects, photographers and others. The non-business user makes much less use of this substantially standardized commercial hand luggage. The image of less business-type hand luggage is usually exclusive; many people however cannot afford to acquire luxury brands. Some more affluent travelers moreover consider such exclusiveness to be (too) impersonal or otherwise undesirable.

### SUMMARY

The present invention provides a luggage device, comprising: one or more wheels for allowing the device to roll over a surface; one or more shell parts of a substantially rigid material which define a substantially closable space of a housing; wherein the housing comprises at least a top surface, a bottom surface, a front surface and a rear surface, wherein the front surface and the rear surface are larger than the top surface and the bottom surface; one or more handles, at least one of which is movable between a first position, in which it is substantially retracted into the rear side of the housing, and a second extended position for rolling the device forward via the wheels during displacement; a seat arranged on the top surface of the housing; and wherein the housing of the luggage device can be positioned substantially upright in a first position so that the seat is directed upward for the purpose of receiving a person thereon.

According to a preferred embodiment the movable handle, in the extended position and during standstill of the device, is adapted to function as a backrest for the person to be received on the seat, thus further increasing the seating comfort of the user.

The handle can take a telescopic form, on the one hand so as to fit into the housing in the retracted position and on the other so as to have sufficient length in the extended position to enable comfortable movement of the luggage device.

A recess for valuable papers and travel documents can also be arranged in the extendable handle. In retracted position these items are received in the housing, where they are well protected against theft.

According to a further preferred embodiment, the seat is arranged inclining slightly forward in the first position, which has the advantage that the seat can be positioned in substantially lying position when the luggage device is inclining to the rear. In order to obtain sufficient rigidity without adversely affecting the space in the housing, the handle which functions as backrest is received substantially in a straight guide in the rear surface of the housing. In the extended position this backrest therefore extends substantially straight relative to the rear surface of the housing. For a user to be able to sit comfortably an angle of more than 90° is desirable between the seat and the backrest, which can be obtained when the seat is arranged inclining slightly forward in the first position.

According to yet another preferred embodiment, the seat forms an angle α relative to the surface on which the housing supports of between 10° and 30°, and more preferably an angle α of between 15° and 25°. This angle can for instance be created in that the rear surface of the housing is given a slightly longer form than the front surface. These angles α have been found to be comfortable. In the tilted state the inclining position ensures that the seat surface provides on the one hand a comfortable position (orientation of the seat surface) and on the other a comfortable seating height. The above stated angle α provides an inclining position of the seat which prevents an elevated edge occurring on the front side during backward tilting. A raised edge is uncomfortable and can even (partly) cut off the blood supply to the legs.

According to yet another preferred embodiment the seat is arranged movably between a rest position, in which the seat lies substantially against the top surface of the housing, and an active position in which the seat extends at least partially forward relative to the housing. Because the seat can be displaced forward to some extent, the seat surface effectively used by the user can be increased and the seating comfort is further improved. A further advantage of the forward displacement of the seat is that the centre of gravity of the person sitting on the luggage device remains positioned substantially above the luggage device, even when for reasons of comfort the luggage device is inclined slightly to the rear. In this way the rigid, boxlike construction of the luggage device can be utilized optimally to transmit to the ground surface the forces exerted by the person sitting on the luggage device. The location of the centre of gravity substantially centrally above the luggage device ensures that the luggage device provides its user with a stable seating accommodation. Because the rigid box shape of the luggage device is used to transmit forces to the ground surface, the arm arranged hingedly on the housing can largely be spared during the force transmission to the ground surface. On the one hand this arm can hereby be given a lighter form, which has a favourable effect on the overall weight of the luggage device. On the other hand reliability is further enhanced.

According to yet another preferred embodiment, the seat is arranged slidably between the first retracted rest position and the second extended active position. The space in the corner between backrest and seat is not a contact surface with the person while he/she is sitting on the seat, whereby the seat can be moved forward in this area without detracting from seating comfort. In addition, a sliding construction can be given a very robust form.

According to yet another preferred embodiment, the seat can be pivoted between the first retracted rest position and the second extended active position, which provides an alternative practicable construction for temporarily increasing the seat surface area.

According to yet another preferred embodiment, a belt fixed to the housing is arranged over at least a part of the seat and functions as handle. The belt is preferably substantially non-stretch and is arranged close-fittingly over the seat. Because a belt is thin but still strong, it is on the one hand sufficiently strong to be used for lifting a luggage device filled with belongings, while on the other the small thickness has a minimal effect on the seating comfort. By attaching the belt to the housing the tensile forces during lifting of the luggage device via the belt are transmitted directly to the housing, whereby the seat does not have to be loaded.

According to yet another preferred embodiment, at least the top surface concealed from view by the seat in the retracted rest position is ribbed, thereby increasing the rigidity of the surface which is loaded when sitting on the luggage device. Because in the case of a slidable seat this top surface is concealed from view by the seat in the retracted rest position, the appearance of the luggage device remains unaffected.

According to yet another preferred embodiment, the rigid material of the shell parts comprises a sandwich structure of two metal plates, between which a plastic intermediate layer is situated. This sandwich structure makes it possible to manufacture a lightweight and rigid construction which makes the use of a reinforcing ribbed structure redundant. On the one hand the internal volume is hereby minimally affected, and a deluxe, exclusive and high-quality look is moreover obtained. A lightweight construction is moreover advantageous when the weight of the luggage to be taken is limited to a maximum.

According to yet another preferred embodiment, at least one of the metal plates is manufactured from aluminium or zinc. The luggage device can be adapted to the wishes of different users through the choice of material.

According to yet another preferred embodiment, the plastic intermediate layer comprises polypropylene or polyethylene, or other suitable plastic. This intermediate layer imparts rigidity, while the product also remains lightweight.

It is also possible to envisage, instead of a plastic intermediate layer, an intermediate layer with a honeycomb structure of for instance aluminium being applied, this also providing a light and rigid construction.

According to yet another preferred embodiment, the device further comprises at least one arm which is arranged pivotally on the housing and on which are arranged the one or more wheels for allowing the device to roll over the ground surface. The pivoting arm is adapted to provide the luggage device with support such that it can be safely inclined backward to some extent and is prevented from falling over. When the luggage device is now inclined backward to some extent, the seat can be positioned in a substantially lying position, while the backrest inclines slightly backward. A user can thus sit even more comfortably, while the luggage device can be given a sufficiently robust and rigid form. Because the wheels are arranged on this arm arranged pivotally on the housing, a reliable placing of the luggage device on the ground surface is ensured. This is because the housing, in the folded-out position of this pivoting arm, makes contact with the ground surface at least with the bottom edge of the rear surface. This bottom edge functions as tilt axis when the luggage device slopes backward and provides a contact with the ground surface which is not susceptible to sliding away, thereby guaranteeing a stable placing.

Although it is possible to envisage that wheels optionally arranged on the housing come off the ground surface or can be temporarily fixed in upright position of the luggage device, in a preferred embodiment all wheels are arranged on the arm arranged pivotally on the housing,

According to yet another preferred embodiment, the bottom surface is chamfered such that, in the folded-out position of the pivoting arm, at least a part thereof makes contact with the ground. The stable placing is hereby improved still further, since the tilt axis on the bottom edge of the rear surface is now assisted by the part of the bottom surface that makes contact with the ground surface. The enlarged surface area with the ground surface moreover provides an effective force transmission of the forces exerted on the luggage device by the person sitting on the luggage device.

According to yet another preferred embodiment, the bottom surface is substantially parallel to the top surface, whereby—in upright position for the purpose of receiving a person on the luggage device—the bottom surface lies against the ground surface and the seat is positioned in substantially lying position on the top surface. In addition, the space available inside the luggage device is maximized by this parallel placing of the surfaces, which moreover provides a characteristic form of a rhombus, or oblique equilateral parallelogram.

According to yet another preferred embodiment, the bottom surface is provided with a chamfered support.

According to yet another preferred embodiment, the arm is arranged pivotally on the rear side of the housing close to the top surface. The arm is hereby brought substantially under strain of pressure when a person sits down on the luggage device. The moment of torque exerted on the hinge is relatively low at the pivot point at this location, this being favourable for the reliability and lifespan of the hinge.

According to yet another preferred embodiment, the maximum angle of rotation of the arm is limited so that the seat is positioned in substantially lying position when the luggage device supports in backward sloping position on the wheel situated at the outer end of the arm and the bottom surface of the housing. When the seat lies in substantially lying position and the backrest forms an angle of more than 90° with the seat, and so inclines slightly backward, an exceptionally comfortable seating accommodation is provided.

According to yet another preferred embodiment, holding means are provided in one or both extreme positions of the arm, such as for instance a snap connection or a magnetic contact. The arm is hereby held to some extent in the extreme positions, so that undesirable folding in or out is prevented.

According to yet another preferred embodiment, the maximum angle of rotation of the arm is limited to an angle β of between 20° and 40°, and more preferably to an angle β of between 25° and 35°. With this maximum angle of rotation the seat can be positioned in substantially lying position.

According to yet another preferred embodiment, the device further comprises a covering which can be attached releasably to the housing and which extends over at least a part of the front surface of the housing. Such a covering makes it possible to make a piece of hand-luggage, to be produced on large scale and at reasonable cost, attractive to many people in that the covering or sleeve can be purchased separately according to personal taste. Such a sleeve can for instance comprise an artwork but can also be more functional and businesslike, for instance because a newspaper, magazine, umbrella and the like can be placed therein. It also becomes possible to make a more or less standardized suitcase suitable for both business and private use, since only the sleeve need be replaced.

According to yet another preferred embodiment, the housing is provided with attaching means and the releasable covering is tensioned between the attaching means. The covering for instance comprises textile fabric such as denim or canvas.

According to yet another preferred embodiment, the device further comprises a carrying device which can be fastened releasably to the housing and which extends over at least a part of the front surface of the housing. In the case that the user is travelling for business purposes, the sleeve can also fulfil the function of laptop bag; when passing through security at an airport the sleeve, which can also form a type of bag, can be uncoupled from a suitcase to be carried through a scanner, while the bag can be easily opened and the laptop shown to security staff. It is also advantageous from an ergonomic viewpoint when a relatively heavy laptop is situated a short distance above the wheels of the suitcase.

According to yet another preferred embodiment, the releasable carrying device is a bag-like object.

According to yet another preferred embodiment, the releasable carrying device is a backpack.

According to yet another preferred embodiment, the baglike object is a cushion which can be removed by the user for the purpose of resting comfortably during a journey or stay.

According to yet another preferred embodiment, the baglike object is inflatable, for instance into a cushion, an airbed or a female figure.

According to yet another preferred embodiment, a loudspeaker is arranged on the housing, to which a portable music player can for instance be connected. If desired, the loudspeaker is detachable from the housing.

According to yet another preferred embodiment, the device is further provided with a battery, with which a portable music player, a mobile telephone, a portable navigation system or the like can for instance be charged. It is also possible to envisage a cigarette lighter being provided, this being powered by the battery. The battery is preferably arranged close to the bottom surface of the housing so that the centre of gravity is kept low, this being favourable for handling during rolling of the luggage device.

According to yet another preferred embodiment, the device is further provided with a solar cell, whereby the battery can be recharged by means of solar energy or peripheral equipment can be directly supplied with energy.

The invention further relates to a method for manufacturing a luggage device as described above.

### BRIEF DESCRIPTION OF THE DRAWINGS

In the following description preferred embodiments of the present invention are further elucidated with reference to the drawing, in which:

FIG. 1 is a perspective view of a luggage device according to the present invention;

FIG. 2 is a perspective view of a luggage device of FIG. 1, wherein the device is in a position suitable for a person to sit thereon;

FIG. 3 is a perspective view of the device shown in FIG. 2, as seen from the rear;

FIG. 4 is a side view of the situation of the device shown in FIGS. 2 and 3; and

FIG. 5 shows a side view of a further preferred embodiment.

### DETAILED DESCRIPTION

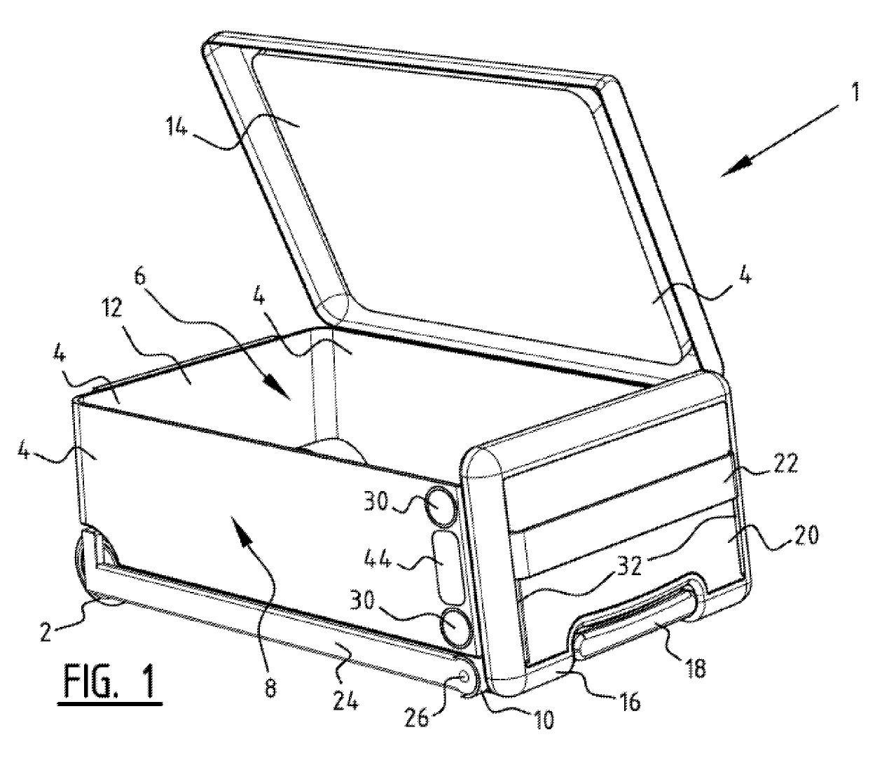

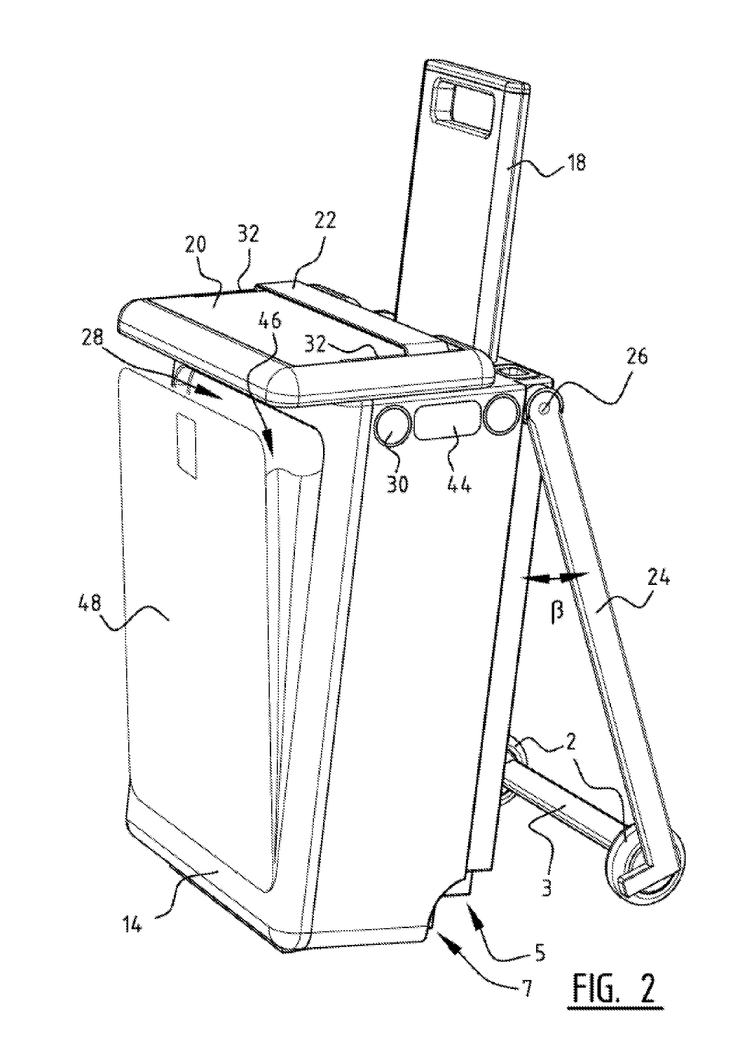

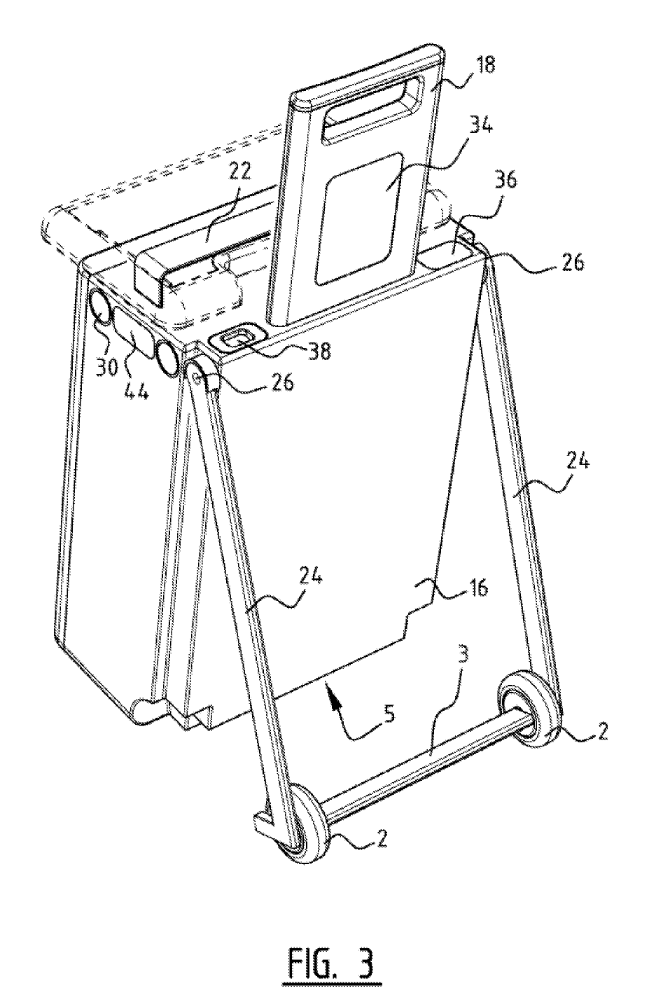

Suitcase 1 shown in FIG. 1 comprises one or more wheels 2 for allowing the suitcase to be rolled over a ground surface. Housing 8 is constructed from shell parts 4 of a substantially rigid material and encloses a closable space 6 in which travel requisites or other objects can be stored. Housing 8 has a top surface 10, a bottom surface 12, a front surface 14 and a rear surface 16, as well as two side surfaces in the shown embodiment. In addition, in the embodiment shown in FIG. 1 the suitcase has two handles 18, 22, of which handle 18 is movable between a first position, substantially retracted into rear side 16 of housing 8 (FIG. 1), and a second extended position (FIG. 2) for rolling the suitcase via the wheels during displacement. The other handle 22 is a substantially non-stretch belt which is attached to housing 8 (FIG. 3, in which seat 20 is shown as transparent for the sake of clarity) and which extends at least partially round seat 20.

When in an alternative embodiment belt 22 is attached to seat 20 instead of to housing 8, this seat 20 can be locked relative to housing 8. This prevents undesirable shifting of seat 20 when a user wishes to displace suitcase 1 using handle 22.

Arranged on top surface 10 of housing 8 is a seat 20 which, when housing 8 of suitcase 1 is positioned substantially upright in a first position, is directed upward for the purpose of receiving a person thereon.

As shown in FIG. 2, movable handle 18 is suitable in the extended position for functioning as backrest for the person to be received on seat 20.

FIG. 2 also shows a storage compartment 46 which is arranged in front surface 14 of housing 8 and which is bounded by the hard-shell surface 28 at the rear, i.e. on the side directed toward the closable inner space 6. Hard-shell surface 28 provides a rigid bounding of the closable space 6 of suitcase 1, which prevents a very overfilled suitcase 1 already causing an outward displacement of storage compartment 46. At the front the storage compartment 46 is bounded by a forward displaceable surface 48. Surface 48 can for instance be given a forward foldable form and/or slightly elastic form. Storage compartment 46 can for instance be used to temporarily store therein clothing, such as a jacket or sweater, or for instance snacks and drinks.

In a preferred embodiment seat 20 is arranged inclining slightly forward, preferably at an angle α of between 10° and 30° and more preferably at an angle α of between 15° and 25°, such as for instance 20°. This inclining position of seat 20 has the advantage that seat 20 is positioned in substantially lying position when the suitcase slopes backward (as in FIG. 2), while the angle between backrest 18 and seat 20 is also more than 90 degrees. Handle 18, which functions as backrest, can be received in a straight guide (not shown) in rear surface 16 of housing 8 and, if desired, takes a telescopic form. In the extended position backrest 18 extends substantially straight relative to rear surface 16 of housing 8, and forms an angle of more than 90 degrees relative to the seat 20 arranged at an angle α.

According to a further preferred embodiment, seat 20 is arranged slidably between a rest position, in which the seat is situated lying substantially against top surface 10 of housing 8, and an active position in which seat 20 extends substantially forward relative to housing 8. Because seat 20 can be displaced forward to some extent, the seat surface area effectively used by the user can be increased and the seating comfort is further improved. Seat 20 is provided with slots 32 through which belt 22, which is attached to top surface 10 of housing 8, can be moved.

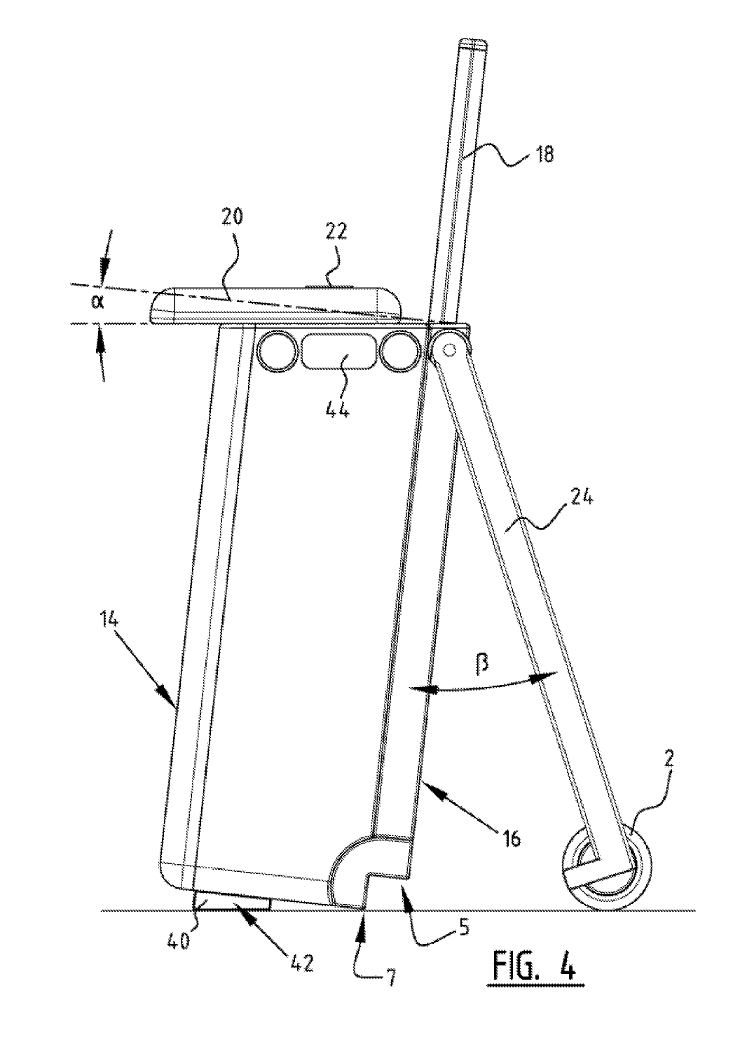

According to yet another preferred embodiment, suitcase 1 further has an arm 24 which is arranged on housing 8 and on which are arranged the one or more wheels 2 for allowing suitcase 1 to roll over the ground surface. This arm 24 is connected by means of a hinge 26 to housing 8. Pivoting arm 24 is adapted to provide suitcase 1 with support such that it can safely be inclined backward to some extent, and is herein kept from falling over (FIGS. 2-4). Arm 24 is limited to a maximum angle of rotation β, which preferably comprises an angle β of between 20° and 40°, and more preferably an angle β of between 25° and 35°. When arm 24 is in this maximally folded-out position and suitcase 1 is inclining backward, seat 20 will be in a substantially lying position while the backrest slopes slightly backward. The user can hereby sit very comfortably while suitcase 1 can be given a sufficiently robust and rigid form, particularly in that handle 18, which functions as backrest, can make use of a straight guide. When suitcase 1 slopes backward, it tilts around bottom edge 7 of rear surface 16. This tilt axis 7 makes contact with the ground surface over substantially the full width of suitcase 1, thereby preventing suitcase 1 from sliding away.

Situated between wheels 2 is a connecting arm 3 which lies substantially against support surface 5 in folded-away position of pivoting arm 24 (as shown in FIG. 1). Load exerted on the wheels is hereby transmitted via connecting arm 3 to the housing of suitcase 1 via support surface 5, thereby sparing hinge points 26.

Suitcase 1 can further be provided with diverse convenient features, such as various compartments 34, 36, 38, 44 for storing paraphernalia therein. Compartment 34 in movable handle 18 is thus provided for storing valuable documents therein, such as passports and tickets. Space 36 can be used for storing for instance cigars therein, while space 38 is adapted especially for receiving for instance an umbrella therein. A compartment 44 is further provided in a side surface of housing 8, as are two loudspeakers 30, to which a sound carrier such as an MP3 player can be connected. This MP3 player can be powered by a battery 42 arranged close to bottom surface 12 of housing 8. Bottom surface 12 of housing 8 can further be provided with a support 40 for supporting suitcase 1 when it is in the substantially upright position.

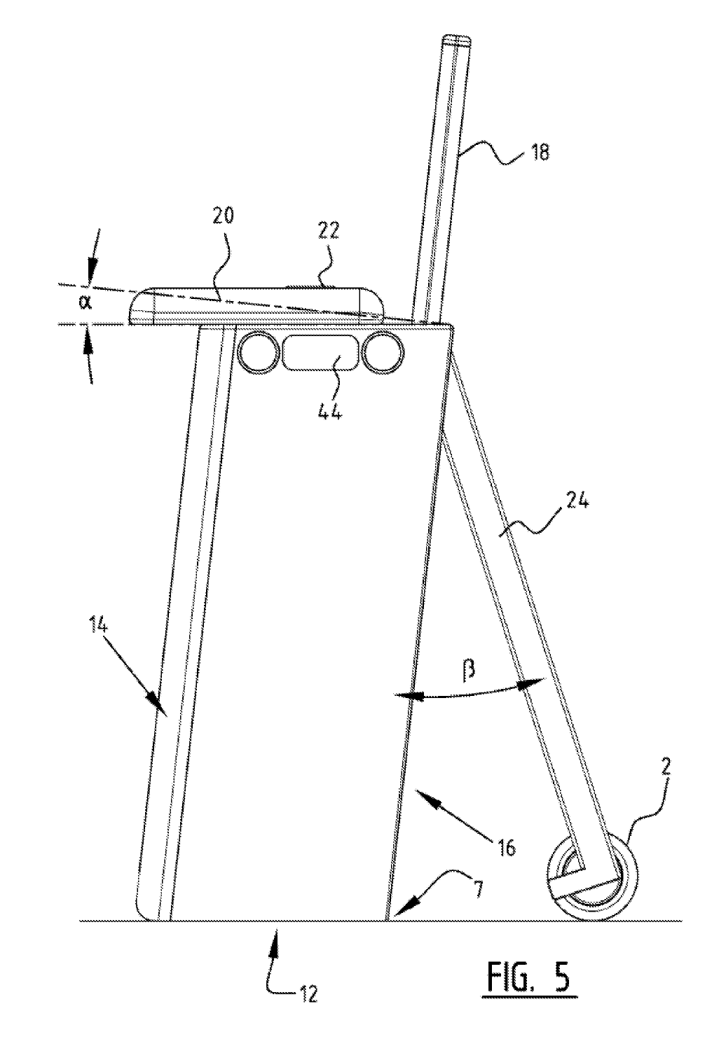

According to a further preferred embodiment, bottom surface 12 is arranged substantially parallel to top surface 10 and seat 20. In the active, upright position shown in FIG. 5 it can clearly be seen that substantially the whole bottom surface 12 hereby makes contact with the ground surface, and therefore acts to transmit to the ground surface forces exerted on suitcase 1, for instance by a person sitting thereon.

Luggage device 1 provides a comfortable seating option, wherein seat 20 is in substantially lying position while backrest 18 inclines slightly backward. With seat 20 moved forward, the centre of gravity of a person sitting on luggage device 1 is located substantially above the rigid box structure of luggage device 1, which ensures an effective force transmission to the ground surface. The contact surface between bottom surface 12 of luggage device 1 is preferably chamfered such that at least a part of bottom surface 12 makes contact with the ground surface. A good force transmission is hereby possible, and luggage device 1 will moreover not be likely to shift when a person sits thereon. A comfortable and reliable seating option is thus provided on a luggage device 1.

Although they show preferred embodiments of the invention, the above described embodiments are intended only to illustrate the invention and not to limit in any way the scope of the invention. It is particularly noted that the skilled person can combine technical measures of the different embodiments. The scope of the invention is therefore defined solely by the following claims.

1. Luggage device, comprising:
one or more wheels for allowing the device to roll over a surface;
one or more shell parts of a substantially rigid material which define a substantially closable space of a housing;
wherein the housing comprises at least a top surface, a bottom surface, a front surface and a rear surface, wherein the front surface and the rear surface are larger than the top surface and the bottom surface;
one or more handles, at least one of which is movable between a first position, in which it is substantially retracted into the rear side of the housing, and a second extended position for rolling the device forward via the wheels during displacement:
a seat arranged on the top surface of the housing;
and
wherein the housing of the luggage device can be positioned substantially upright in a first position so that the seat is directed upward for the purpose of receiving a person thereon.

2. Luggage device as claimed in claim 1, wherein the movable handle is adapted to function in the extended position as a backrest for the person to be received on the seat.

3. Luggage device as claimed in claim 1, wherein the seat is arranged inclining slightly forward in the first position.

4. Luggage device as claimed in claim 3, wherein the seat forms an angle α relative to the surface on which the housing supports of between 10° and 30°.

5. Luggage device as claimed in claim 1, wherein the seat is arranged movably between a rest position, in which the seat lies substantially against the top surface of the housing, and an active position in which the seat extends at least partially forward relative to the housing.

6. Luggage device as claimed in claim 5, wherein the seat is arranged slidably between the first retracted rest position and the second extended active position.

7. Luggage device as claimed in claim 5, wherein the seat can be pivoted between the first retracted rest position and the second extended active position.

8. Luggage device as claimed in claim 1, wherein a belt fixed to the housing is arranged over at least a part of the seat.

9. Luggage device as claimed in claim 1, wherein at least the top surface of the device, which top surface is concealed from view by the seat when the seat is in a retracted rest position, is ribbed.

10. Luggage device as claimed in claim 1, wherein the rigid material of the shell parts comprises a sandwich structure of two metal plates, between which a plastic intermediate layer is situated.

11. Luggage device as claimed in claim 10, wherein at least one of the metal plates is manufactured from aluminium or zinc.

12. Luggage device as claimed in claim 10, wherein the plastic intermediate layer comprises polypropylene or polyethylene.

13. Luggage device as claimed in claim 1, further comprising at least one arm which is arranged pivotally on the housing and on which are arranged the one or more wheels for allowing the device to roll over the ground surface.

14. Luggage device as claimed in claim 13, wherein all wheels are arranged on the arm arranged pivotally on the housing.

15. Luggage device as claimed in claim 14, wherein the bottom surface is chamfered such that, in the folded-out position of the pivoting arm, at least a part thereof makes contact with the ground.

16. Luggage device as claimed in claim 15, wherein the bottom surface and top surface are substantially parallel to each other.

17. Luggage device as claimed in claim 15, wherein the bottom surface is provided with a chamfered support.

18. Luggage device as claimed in claim 13, wherein the arm is arranged pivotally on the rear side of the housing close to the top surface.

19. Luggage device as claimed in claim 13, wherein the maximum angle of rotation of the arm is limited so that the seat is positioned in substantially lying position when the luggage device is supported on the one or more wheels that are situated at the outer end of the arm and the bottom surface of the housing.

20. Luggage device as claimed in claim 19, wherein the maximum angle of rotation of the arm is limited to an angle β of between 20° and 40°.

21. Luggage device as claimed in claim 1, further comprising a covering which can be attached releasably to the housing and which extends over at least a part of the front surface of the housing.

22. Luggage device as claimed in claim 21, wherein the housing is provided with attaching means and the releasable covering is tensioned between the attaching means.

23. Luggage device as claimed in claim 1, further comprising a carrying device which can be fastened releasably to the housing and which extends over at least a part of the front surface of the housing.

24. Luggage device as claimed in claim 23, wherein the releasable carrying device is a bag-like object.

25. Luggage device as claimed in claim 23, wherein the releasable carrying device is a backpack.

26. Luggage device as claimed in claim 24, wherein the bag-like object is a cushion.

27. Luggage device as claimed in claim 24, wherein the bag-like object is inflatable.

28. Luggage device as claimed in claim 1, wherein a loudspeaker is arranged on the housing.

29. Luggage device as claimed in claim 1, further provided with a solar cell.

30. Luggage device as claimed in claim 1, further provided with a battery.

31. Method for manufacturing a luggage device as claimed in claim 1.
